(19) United States
(12) Patent Application Publication
(10) Pub. No.: US 2008/0194370 A1
(43) Pub. Date: Aug. 14, 2008

(54) Transmission System With Safety Device

(75) Inventors: William Wesley Martin, Milton Keynes (GB); Anthony Joseph Child, Milton Keynes (GB)

Correspondence Address: KNOBBE MARTENS OLSON & BEAR LLP, 2040 MAIN STREET, FOURTEENTH FLOOR, IRVINE, CA, 92614, US

(73) Assignee: ZEROSHIFT LIMITED, MILTON KEYNES (GB)

(21) Appl. No.: 11/914,223

(22) PCT Filed: May 15, 2006
(86) PCT No.: PCT/GB2006/001798

§ 371 Date: Feb. 27, 2008

(30) Foreign Application Priority Data
May 14, 2005 (GB) 0509882.7
May 11, 2006 (GB) 0609333.0

(51) Int. Cl. F16H 31/00

(52) U.S. Cl. 475/119

(57) ABSTRACT

A transmission system with a safety device for preventing lockup occurring. The transmission includes a first gear train (7) having a first gear element (17), a second gear train (9) having a second gear element (21), a first gear selector device (29) arranged for selecting the first gear element (29), a first actuator for controlling the operation of the first gear selector device, a second gear selector device (31) arranged for selecting the second gear element (21), a second actuator for controlling operation of the second gear selector device and a safety device (55) for preventing the first and second gear selector devices (29, 31) from simultaneously applying torque to the first and second gear elements (17, 21) in opposed directions.

The present invention relates to transmission systems and selector mechanisms used in transmission systems to select a gear train, for example dog-type selector mechanisms.

This application refers to a system and method for the elimination of a failure mode that can occur in transmission systems of the type described in WO 2004/099654, WO 2005/005868, WO 2005/005869, WO 2005/024261 and WO 2005/026570. However, similar problems may occur in other types of transmission systems.

The known systems disclosed in the above-mentioned publications are examples of instantaneous transmission systems. The known transmissions have a plurality of gear trains for transmitting drive between a transmission input shaft and a transmission output shaft. For a first gear train, a first gear wheel is rotatably mounted on one of a transmission input shaft and an output shaft and a second gear wheel is fixed to the other shaft, in mesh with the first gear wheel. A second gear train comprising third and fourth gear wheels is similarly arranged. The transmission also includes at least one gear selector mechanism that is located between the rotatably mounted gear wheels that is arranged to selectively lock them for rotation with the shaft on which they are mounted. When a gear wheel from a gear train is locked for rotation with the shaft, drive is transmitted between the input and output shafts via that gear train.

The arrangement is such that when drive is transmitted between the input and output shafts via one of the gear trains, for example the first gear train, the gear selector mechanism can select the new (second) gear train under power without disengaging the first gear train, by locking the rotatably mounted gear wheel of the second gear train to its shaft. Thus momentarily, drive is transmitted between the input and output shaft via two gear trains. The new gear train then overdrives the first gear train and the selector mechanism disengages the first gear wheel. Drive is then transmitted between the input and output shafts via the new gear train only, thus providing uninterrupted power through a gearshift. The selector mechanism is arranged such that the gearshifts can take place under acceleration or deceleration.

The gear selector mechanisms of the known transmissions have four modes with respect to each adjacent gear train:
Fully engaged in both torque directions (fully in gear);
Disengaged in both torque directions (neutral);
Engaged in the forward torque direction while disengaged in the reverse torque direction;
Disengaged in the forward torque direction while engaged in the reverse torque direction.

The last two of the above four modes enable a discrete ratio gearbox to have the ability to shift up or down ratios instantly under load without torque interruption.

There is an inherent failure mode in any gearbox with more that two gear trains that has both of the last two modes. Thus it is possible in instantaneous transmission systems having at least three gear trains for two gears to be engaged simultaneously with opposing modes under some conditions, which causes the transmission to lock up. One of the most dangerous scenarios is if the direction of torque changes during a shift. If torque has a constant known direction during a shift, the natural sequence of events prevents the above failure mode. During a sudden reversal of the direction of torque immediately prior to, or during a shift, there is potential for the above failure mode to occur.

A transmission system typically includes at least three gear trains, and is likely to include four to six gear trains. A transmission having four gear trains requires two instantaneous gear selector mechanisms. The first gear selector mechanism is arranged to selectively engage the first and second gear trains and the second gear selector mechanism is arranged to selectively engage the third and fourth gear trains. Each gear selector mechanism includes first and second sets of engagement members having opposing ends with fixed opposing directions of torque transfer. This provides an inherent fail-safe arrangement against the above mentioned failure mode where the shift is from a gear on one side of the hub (selector mechanism) to a gear on the other side of the same hub, for example when the first selector mechanism selects between the first and second gears or when the second selector mechanism selects between the third and fourth gears.

The above failure mode can only occur if a gearshift is from a gear that is engageable by one of the gear selector mechanisms to a gear that is engageable by the other gear selector mechanism, for example when changing between second and third gears in the four speed transmission mentioned above, since this requires movement of both the first and second gear selector mechanisms. The first gear selector mechanism has to move out of engagement with the second gear train and the second gear selector mechanism has to move into engagement with the third gear train. If a torque reversal occurs when the second gear is still engaged by the first selector mechanism and the third gear is engaged by the second selector mechanism, the transmission may lock up.

The transmission described in PCT/GB2006/000743 addresses the above-mentioned problems by using a layout that is inherently safe. The layout ensures that each gear change takes place across the hub of a single gear selector devices, which is inherently safe. This is achieved by including a gear train that is arranged to be selected by the first and second instantaneous gear selector devices and by alternating subsequent gear selector devices on the input and output shafts of the transmission.

WO 2005/0058648 describes an electronic control system for measuring the direction of torque in the gearbox and managing some shifts such as a kick-down shift. By measuring the magnitude and direction of torque on all shifts it is possible to prevent gearbox lock up due to conflicting modes being engaged in two gears at once. However, control systems are complex and may introduce new failure modes into the transmission system. Since the control system does not affect the relative positions of the gear trains and the selector mechanisms in the instantaneous transmissions described above, the transmission layout remains inherently prone to the failure modes mentioned above should a problem occur with the control system.

Accordingly the present invention seeks to provide an improved transmission system that mitigates at least some of the aforementioned problems or at least provides an alternative solution to those problems.

According to one aspect of the present invention, there is provided a transmission system including, a first gear train having a first gear element, a second gear train having a second gear element, a first gear selector device arranged for selecting the first gear element, a first actuator for controlling the operation of the first gear selector device, a second gear selector device arranged for selecting the second gear element, a second actuator for controlling operation of the second gear selector device and a safety device for preventing the first and second gear selector devices from simultaneously applying torque to the first and second gear elements in opposed directions. This prevents potential lockup occurring.

Preferably the safety device is a blocking device.

Advantageously the first gear element is rotatably mounted on a first shaft and the first gear selector device is arranged to selectively lock the first gear element for rotation with the first shaft. Preferably the second gear element is rotatably mounted on the first shaft and is arranged to be selectively locked for rotation with the first shaft by the second gear selector device. Alternatively, the second gear wheel can be rotatably mounted on a second shaft and the second gear selector device is arranged to selectively lock the second gear element for rotation with the second shaft.

Preferably the safety device is constructed and arranged to prevent the second gear selector device from locking the third gear element for rotation with the first shaft and the first gear selector device from locking the first gear wheel with the first shaft simultaneously such that torque is applied to the first shaft in opposed directions.

Preferably the first gear train includes a third gear element and the second gear train includes a fourth gear element. The transmission may include additional gear ratios, for example the transmission may include a third gear train having fifth and sixth gear elements, and a fourth gear train having seventh and eighth gear elements. Preferably the fifth gear element is rotatably mounted on the first shaft and is arranged to be selectively locked for rotation therewith by the first gear selector device. Preferably the seventh gear element is rotatably mounted on the first shaft and is arranged to be selectively locked for rotation therewith by the second gear selector device.

For transmission systems including more than four gear ratios, additional gear trains and can be included together with additional gear selector devices. Typical transmissions include between four and ten gear ratios and between two and five gear selector devices. Drive is transmitted between the first and second shafts via the gear trains (gear ratios) when a particular ratio is selected.

The first and second selector devices are arranged such that they can simultaneously engage their respective gear wheels. Advantageously the safety device is arranged to prevent the first selector device applying an accelerating force to the first gear element and the second gear selector device from applying a decelerating force to the second gear element simultaneously. Preferably the safety device is arranged to prevent the first selector device applying a decelerating force to the first gear element and the second gear selector device from applying an accelerating force to the second gear element simultaneously.

Advantageously the blocking device does not prevent simultaneous engagement of the first and third gear elements in the same direction.

Advantageously the blocking device is arranged to control the separation of engagement members of the first and second gear selector devices.

The safety device can be arranged to control the separation between the first set of engagement members of the first gear selector device and the second set of engagement members of the second gear selector device. Preferably the safety device includes a first control member arranged to limit the relative movement between the first set of engagement members of the first gear selector device and the second set of engagement members of the second gear selector device thereby preventing simultaneous engagement with their respective gear elements that would cause torque to be applied in opposite directions.

Advantageously the first control member can be arranged to provide a predetermined minimum separation between acceleration parts of the engagement members of the second gear selector device and deceleration parts of the engagement members of the first gear selector device. For example, the first control member may be an arm that extends between the actuator parts of the first and second gear selector devices that is arranged to block or interfere with the movement of the sets of engagement members such as the acceleration parts of the second gear selector device that engage the third gear element and the deceleration parts of the first gear selector device that engage the first gear element. The arm is dimensioned to control the separation of the sets of engagement members to prevent undesirable simultaneous gear element engagements.

The safety device can be arranged to control the separation between the second set of engagement members of the first gear selector device and the first set of engagement members of the second gear selector device. Preferably the safely device includes a second control member arranged to limit the relative movement between the sets of engagement members to prevent simultaneous engagement with their respective gear elements that would cause torque to be applied in opposite directions. For example, the second control member may be an arm that extends between the actuator parts of the first and second gear selector devices that is arranged to block or interfere with the movement of the sets of engagement members. The arm is dimensioned to control the separation of the sets of engagement members.

Advantageously the second control member can be arranged to provide a predetermined minimum separation between deceleration parts of the engagement members of the second gear selector device and acceleration parts of the engagement members of the first gear selector device. For example, each set of engagement members for each gear selector device includes acceleration engagement parts and deceleration engagement parts. The sets of engagement members are arranged opposite handed such that a gear element can be engaged by acceleration parts from the first set of engagement members and deceleration parts from the second set of engagement members. The gear element on the opposite side of the gear selector device can be engaged by acceleration parts from the second set of engagement members and deceleration parts from the first set of engagement members.

Advantageously the first gear selector device can be arranged such that when a braking force is transmitted the first set of engagement members drivingly engages the first gear element, and the second set of engagement members is in an unloaded condition, and when a driving force is transmitted the second set of engagement members drivingly engages the first gear element, and the second set of engagement members is then in an unloaded condition.

Advantageously the second gear selector device is arranged such that when a braking force is transmitted the second set of engagement members drivingly engages the third gear element and the first set of engagement members is in an unloaded condition, and when a driving force is transmitted the first set of engagement members drivingly engages the third gear element and the second set of engagement members is then in an unloaded condition.

Preferably the first and/or second gear selector devices is/are arranged to bias a loaded set of engagement members towards an unengaged gear element without disengaging the loaded set of engagement members from the engaged gear element.

Advantageously the first and second sets of engagement members are arranged to rotate, in use, with the shaft on which it is mounted. The first shaft may be an input shaft in one embodiment and an output shaft in another embodiment. The second shaft is the other of the input and output shafts.

Preferably the actuator mechanism for controlling movement of the sets of engagement members for a particular gear selector device can be arranged to control the movement of both sets of engagement members. For example, the actuator mechanism can include a first guide device and resilient member arrangement for the first set of engagement members, a second guide device and resilient member arrangement for the second set of engagement members, and an actuator for controlling movement of the first and second guides. The first and second guide devices are arranged such that their relative positions to each other are fixed and the actuator causes the first and second guides to move substantially simultaneously.

The first and second sets of engagement members are moveable into and out of engagement with their gear elements independently of each other. The arrangement is such that when a driving force is transmitted via a gear train, one of the first and second sets of engagement members drivingly engages the engaged gear element and the other set of engagement members is then in an unloaded condition. For example, if the first set of engagement members of the first gear selector device is loaded when a driving force is transmitted via the first gear train, the second set of engagement members is unloaded. When a gear shift takes place to select the third gear train, the actuator assembly is arranged to move the unloaded (second) set of engagement members into driving engagement with the unengaged gear element (the fifth gear element) to effect a gear change. When the fifth gear element is engaged, momentarily drive is transmitted between the first and second shafts via both the first and third gear trains. This is an example of an instantaneous gear selector transmission.

Advantageously the first selector device is arranged to select between the following four modes of operation with respect to the first gear element: fully engaged in both torque directions; disengaged in both torque directions; engaged in the forward torque direction while disengaged in the reverse torque direction; and disengaged in the forward torque direction while engaged in the reverse torque direction.

Advantageously the second gear selector device is arranged to select between the following four modes of operation with respect to the second gear element: fully engaged in both torque directions; disengaged in both torque directions; engaged in the forward torque direction while disengaged in the reverse torque direction; and disengaged in the forward torque direction while engaged in the reverse torque direction.

An embodiment of the present invention will now be described, by way of example only, with reference to the accompanying drawings in which like references indicate equivalent features, wherein:

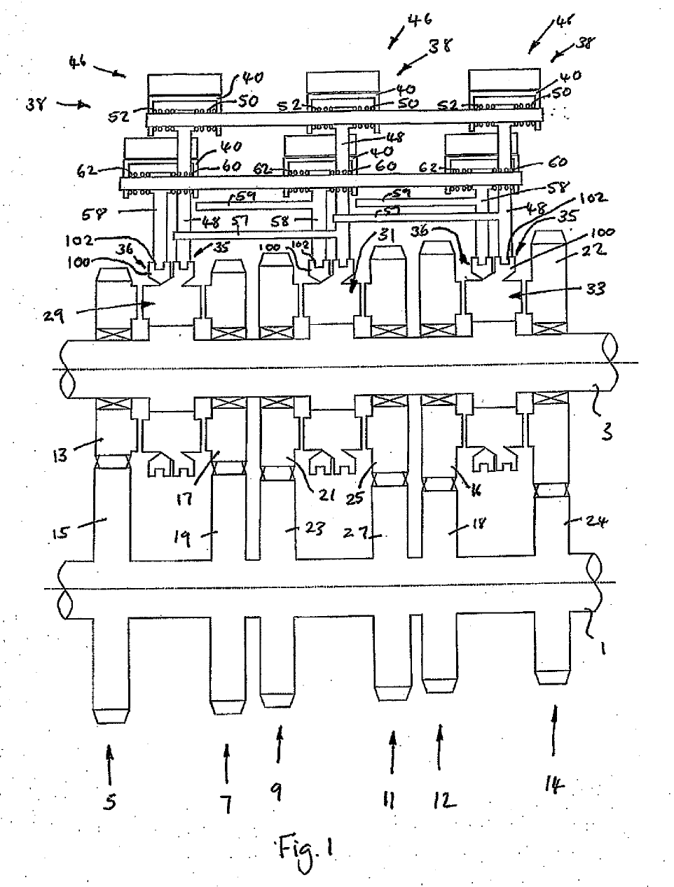

FIG. 1 is a sectional view of a general arrangement of a transmission system in accordance with the present invention;

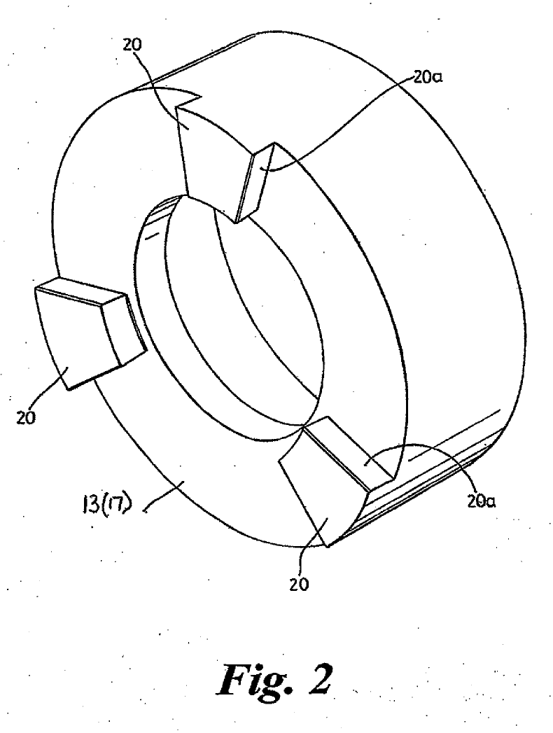

FIG. 2 is a schematic that illustrates the arrangement of a group of dogs on a side of a gear (teeth not shown for clarity);

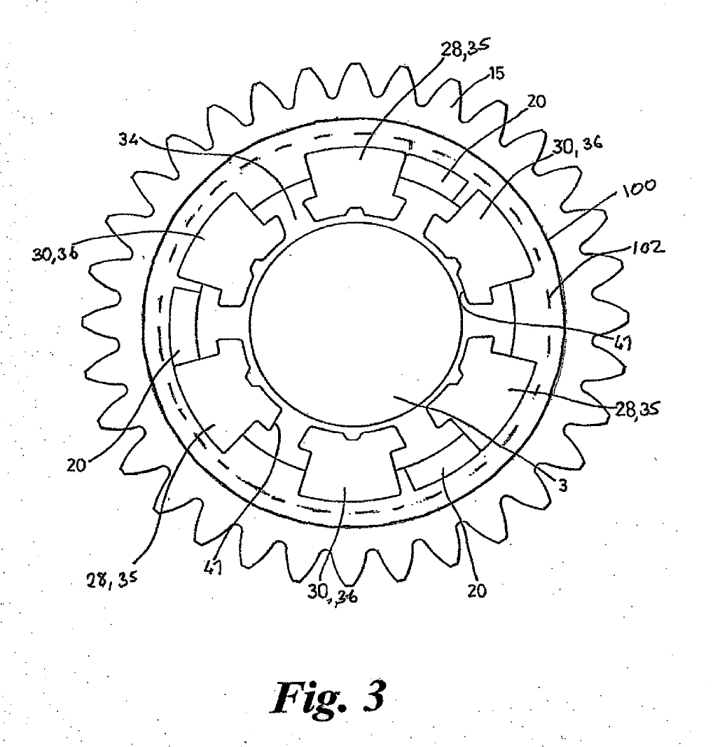

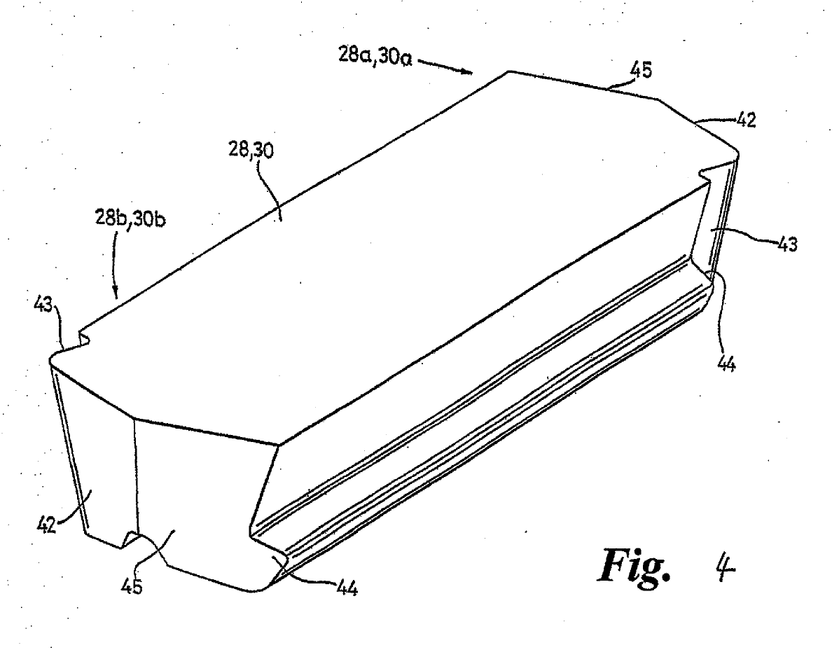

FIG. 3 is a schematic that illustrates the interaction of a selector mechanism and the dogs on the side of a gear wheel;

FIG. 4 is a perspective view of an engagement bar from the selector mechanism;

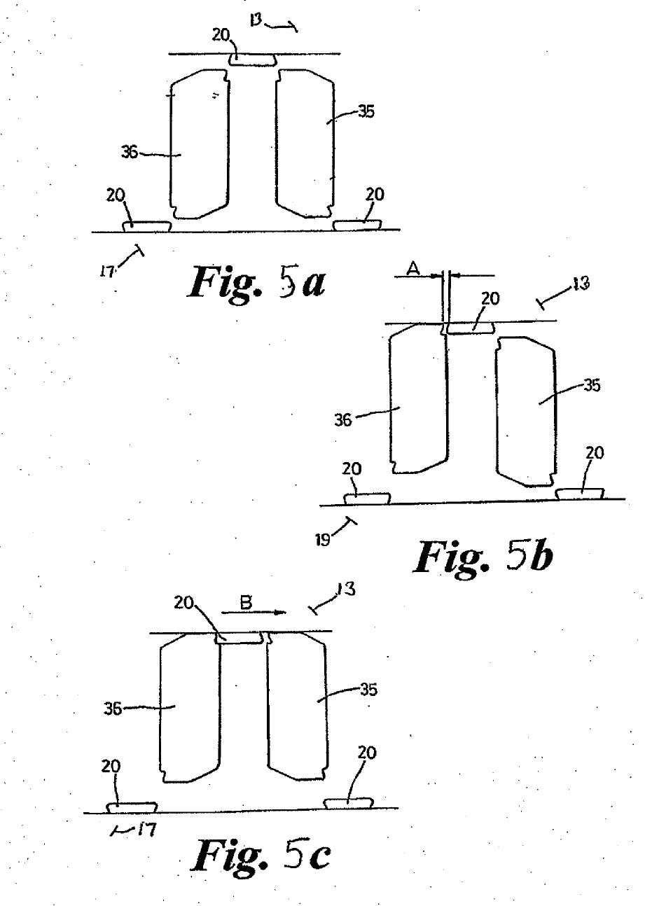

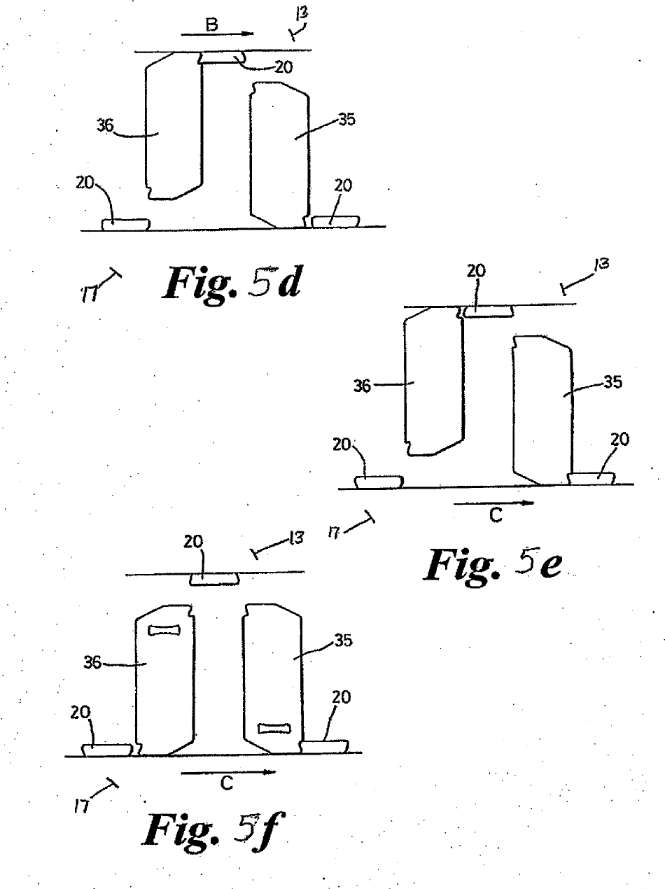

FIG. 5a-f illustrate diagrammatically operation of the selector mechanism;

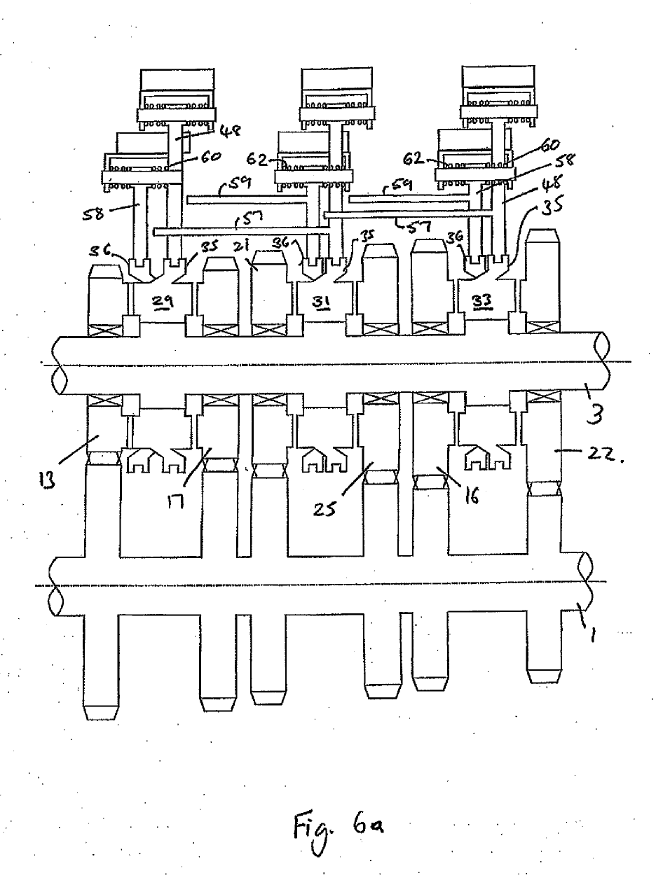

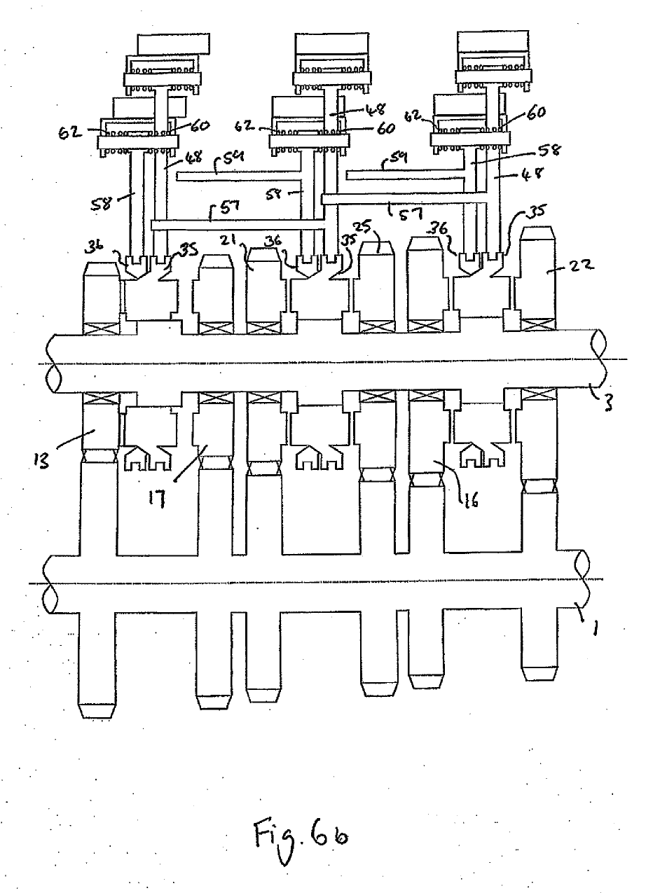

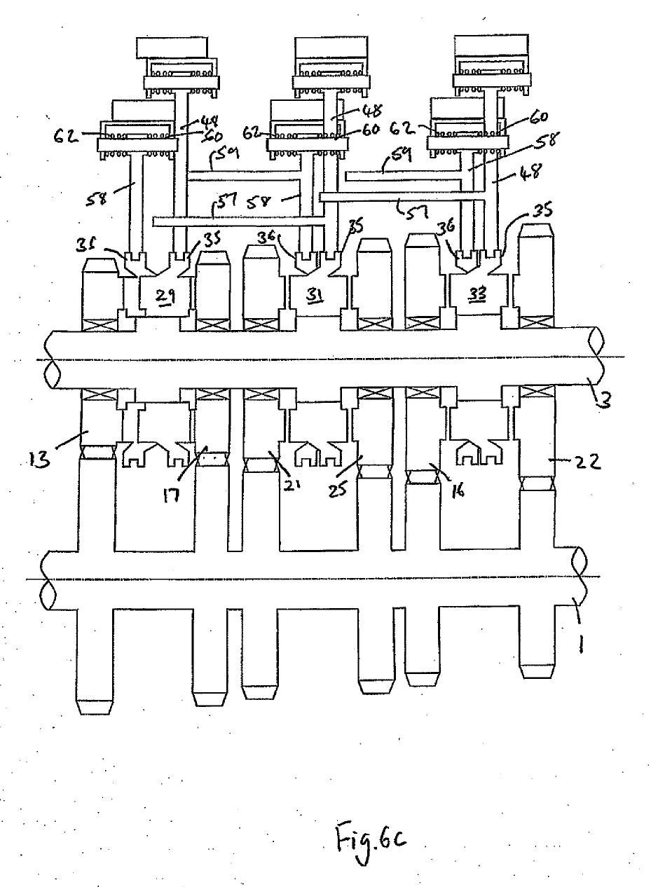

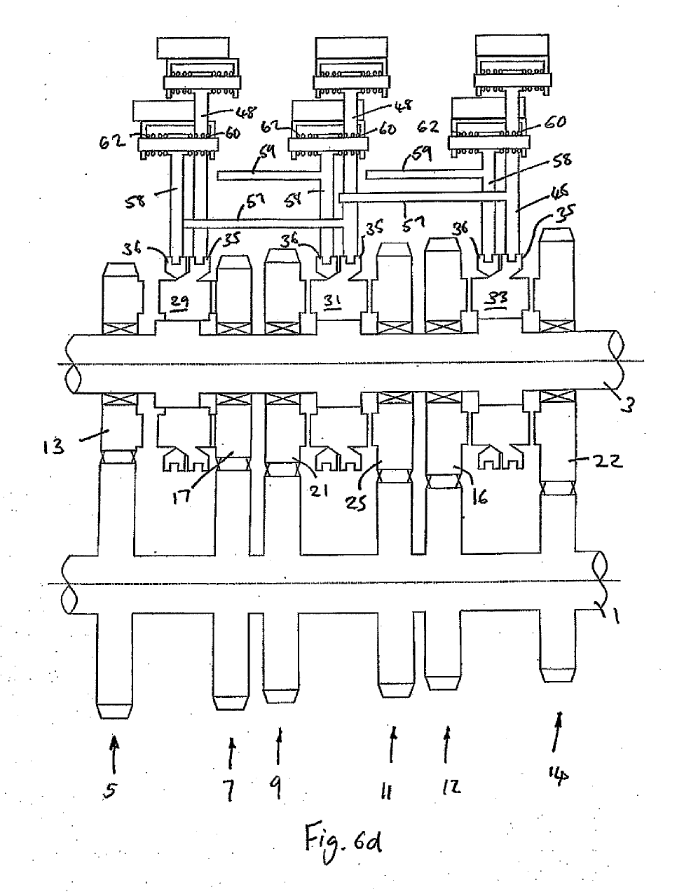

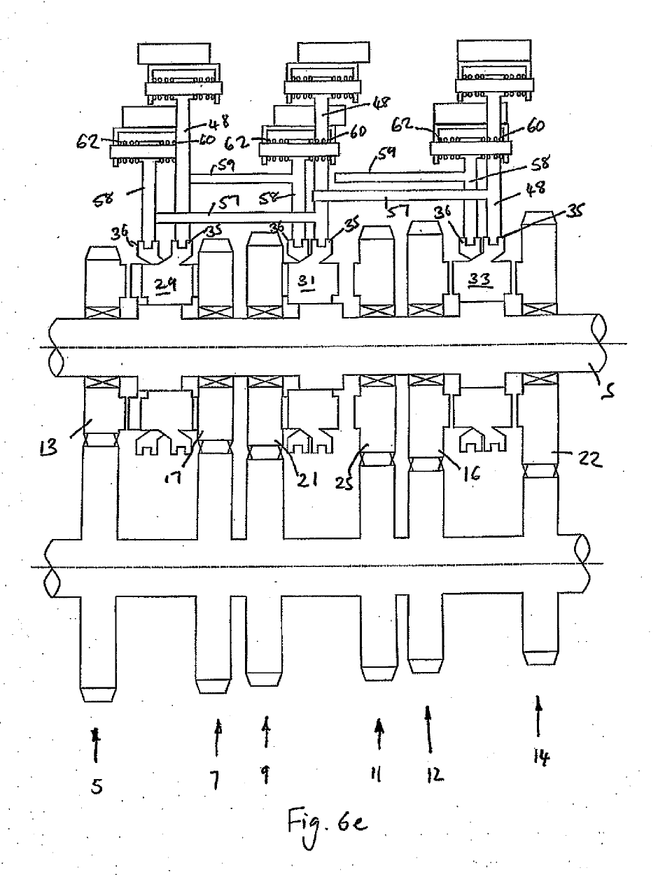

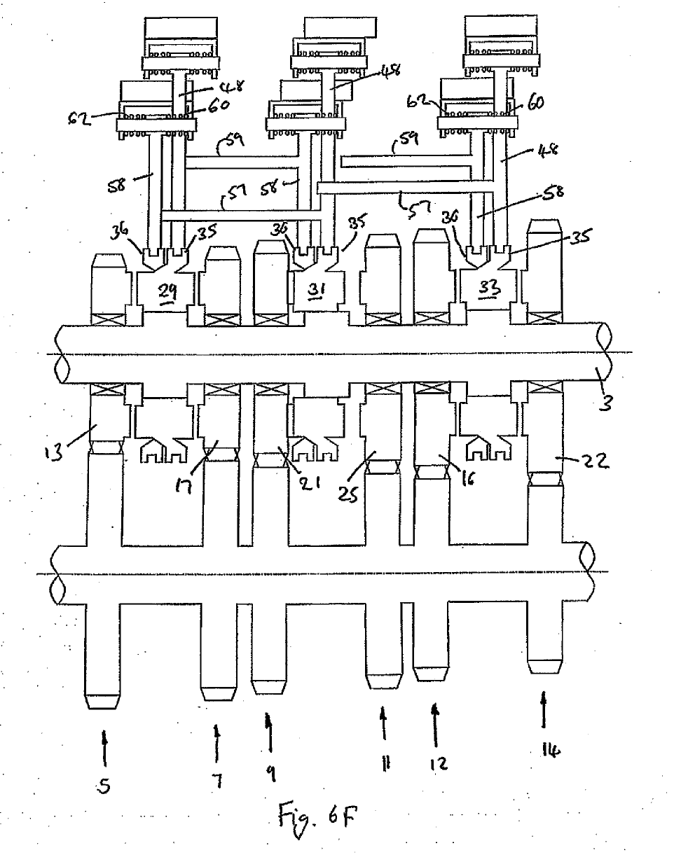

FIG. 6a-f illustrate diagrammatically operation of the transmission with a blocking device.

### TRANSMISSION LAYOUT

FIG. 1a shows a transmission including an input shaft 1, an output shaft 3 and first, second, third, fourth, fifth and sixth gear trains (or gear ratios) 5,7,9,11,12,14 (1^{st},2^{nd},3^{rd},4^{th},5^{th} and 6^{th}) arranged to transmit drive between the input and output shafts 1,3. The first gear train 5 comprises a first gear wheel 13 rotatably mounted on the output shaft 3 via a bearing and a second gear wheel 15 fixed to the input shaft 1 in mesh with the first gear wheel 13. The second gear train 7 comprises a third gear wheel 17 rotatably mounted on the output shaft 3 and a fourth gear wheel 19 fixed to the input shaft 1 in mesh with the third gear wheel 17. The third gear train 9 comprises a fifth gear wheel 21 rotatably mounted on the output shaft 3 and a sixth gear wheel 23 fixed to the input shaft 1 in mesh with the fifth gear wheel 21. The fourth gear train 11 comprises a seventh gear wheel 25 rotatably mounted on the output shaft 3 and an eighth gear wheel 27 fixed to the input shaft 1 in mesh with the seventh gear wheel 25. The fifth gear train 12 comprises a ninth gear wheel 16 rotatably mounted on the output shaft 3 and a tenth gear wheel 18 fixed to the input shaft 1 in mesh with the ninth gear wheel 16. The sixth gear train 14 comprises an eleventh gear wheel 22 rotatably mounted on the output shaft 3 and a twelfth gear wheel 24 fixed to the input shaft 1 in mesh with the seventh gear wheel 25.

First, second and third selector mechanisms 29,31,33 are also mounted on the output shaft 3. Each selector mechanism 29,31,33 is arranged to selectively transmit drive between the output shaft 3 and input shaft 1 via the gear trains by selectively locking the gear wheels rotatably mounted on the output shaft 3 for rotation with the output shaft 3. The first selector mechanism 29 is arranged to selectively lock the first gear wheel 13 from the 1^{st} gear ratio and third gear wheel 17 from the 2^{nd} gear ratio for rotation with the output shaft 3. The second selector mechanism 31 is arranged to to selectively lock the fifth gear wheel 21 from the 3rd gear ratio and the seventh gear wheel 25 from the 4th gear ratio for rotation with the output shaft 3. The third selector mechanism 31 is arranged to selectively lock the ninth gear wheel 16 from the 5th gear ratio and the eleventh gear wheel 22 from the 6^{th} gear ratio for rotation with the output shaft 3.

When a gear wheel is engaged by a gear selector mechanism it is locked for rotation with the output shaft 3. So, for the third gear train 9, when the second gear selector mechanism 31 engages the fifth gear wheel 21 and the first and third gear selector mechanisms 29,33 are in neutral (no gear wheels engaged) drive is transmitted between the input and output shafts 1,3 via the third gear train 9.

Selector and Actuator Mechanisms

Each selector mechanism 29,31,33 is similar and is mounted on the output shaft 3 in a similar manner. The structure of the first gear selector mechanism 29 and the way in which it selectively engages the first and third gear wheels 13,17 will now be described. However, the general structure and principles of operation are applicable to the second and third gear selector mechanisms 31,33 and their respective gear wheels.

The gear selector mechanism 29 is arranged to engage drive formations 20 located on the first and third gear wheels 13,17. The drive formations 20 on each gear wheel 13,17 comprise groups of dogs. Similar drive formations are located on the fifth, seventh, ninth and eleventh gear wheels 21,23,28,32.

The first dog group 20 is located on one side of the first gear wheel 13. The dogs are preferably formed integrally with the first gear wheel, but this is not essential. The first dog group 20 comprises three dogs evenly circumferentially distributed about the gear face, i.e. the angle subtended between the centres of a pair of dogs is approximately 120° (see FIGS. 2 and 3). The second dog group 20, comprises three dogs and is similarly arranged on one side of the third gear wheel 17. Three dogs are used because this arrangement provides large engagement windows, that is the spaces between the dogs, to receive the engagement bars. Large engagement windows provide greater opportunities for the first gear selector mechanism 29 to fully engage the gear wheels 13,17 before transmitting drive thereto. If the first gear selector mechanism 29 drives a gear wheel when only partially engaged it can lead to damage of the dogs and/or the first gear selector mechanism 29.

The first and third gear wheels 13,17 are mounted spaced apart on the output shaft 3 and are arranged such that the sides including the first and second dog groups face each other.

The first gear selector mechanism 29 includes first and second sets of engagement bars 35,36 and an actuator assembly 38.

The first and second sets of engagement bars 35,36 are mounted on the output shaft 3 between the first and third gear wheels 13,17. The first set of engagement bars 35 comprises three bars 28 that are evenly distributed about the output shaft 3 such that their bases face inwards, and the axes of the bars 28 are substantially parallel. The second set of engagement bars 36 comprises three bars 30 which are similarly arranged about the output shaft 3.

The sets of engagement bars 35,36 are mounted on a sleeve 34 which is mounted on the output shaft 3 between the first and second gear wheels 3,5 (see FIGS. 1 and 3). The sets of engagement bars 35,36 are arranged to rotate with the output shaft 3 but are able to slide axially along the sleeve 34 and the output shaft 3 in response to a switching action of the actuator assembly 38. To facilitate this, the sleeve 34 includes six keyways 41 formed in its curved surface with each engagement bar 28,30 having a complementary formation in its base. The keyways 41 may have substantially T-shaped profiles such that the bars are radially and tangentially (but not axially) restrained within the keyways 41 (see FIG. 2). Alternatively, the keyways 41 can have slotted or dovetailed profiles to radially restrain the bars.

Preferably the bars are configured to be close to the output shaft 3 to prevent significant cantilever effects due to large radial distances of loaded areas thus reducing the potential for structural failure.

The arrangement of the bar sets 35,36 is such that bars of a particular set are located in alternate keyways 41 and the bar sets 35,36 can slide along the sleeve 34. The bars in each bar set are rigidly connected to each other by an annular member 100 and move as a unit. Each bar set can move independently of the other. The annular member 100 has a groove 102 formed in its outer curved surface that extends fully around the annular member. The bars 28 in the first set of engagement bars 35 are preferably integrally formed with its annular member, though this is not critical. The bars 28 are evenly distributed about the annular member 100. The second set of engagement bars 36 comprises three bars 30, which are held in a similar fixed arrangement by a second annular member 100. When there is relative movement between the first and second sets of bars 35,36, the annular member 100 of the first bar set 35 slides over the second set of bars 36 and the annular member 100 of the second bar set 36 slides over the first set of bars 35.

Each bar 28 in the first bar set 35 has a first end 28a arranged to engage the first group of dogs 20 attached to the first gear wheel 13 and a second end 28b arranged to engage the second group of dogs 20 on the third gear wheel 17. The first and second ends 28a,28b typically have the same configuration but are opposite handed, for example the first end 28a is arranged to engage the first group of dogs 20 during deceleration (reverse torque direction) of the first gear wheel 13 and the second end 28b is arranged to engage the second group of dogs 20 during acceleration (forward torque direction) of the third gear wheel 17. Each bar 30 in the second bar set 36 is similarly arranged, except that the first end 30a is arranged to engage the first group of dogs 20 during acceleration of the second gear wheel 15 and the second end 30b is arranged to engage the second group of dogs 20 during deceleration of the third gear wheel 17.

When both the first and second sets of engagement bars 35,36 engage a gear wheel drive is transmitted between the input and output shafts 1,3 whether the gear is accelerating or decelerating.

The first and second ends 28a,30a,28b,30b of each bar include an engagement face 43 for engaging the dogs 20, a ramp 45, an end face 42 and may include a shoulder 44 (see FIG. 4). The end faces 42 limit the axial movement of the engagement bars 28,30 by abutting the sides of the gear wheels. The engagement faces 43 may be angled to complement the sides of the dogs 20a so that as the engagement bars 28,30 rotate into engagement, there is face-to-face contact to reduce wear. Each ramp 45 is preferably helically formed and slopes away from the end face 42. The angle of inclination of the ramp 45 is such that the longitudinal distance between the edge of the ramp furthest from the end face 42 and the plane of the end face 42 is larger than the height of the dogs 20. This ensures that the transmission does not lock up when there is relative rotational movement between the engagement bars 28,30 and the dogs 20 that causes the ramp 45 to move towards engagement with the dogs 20. The dogs 20 do not crash into the sides of the engagement bars 28,30 but rather engage the ramps 45. As further relative rotational movement between the dogs 20 and the engagement bars 28,30 occurs, the dogs 20 slide across the ramps 45 and the helical surfaces of the ramps cause the engagement bars 28,30 to move axially along the output shaft 3 away from the dogs 20 so that the transmission does not lock up.

The arrangement of the gear selector mechanism is such that it inherently prevents lockup of the transmission occurring when selecting a new gear.

When the bars of the first and second sets 35,36 are interleaved, as in FIG. 3, the engagement faces 43 of the first ends 28a of the first set of bars 35 are adjacent the engagement faces 43 of the first end 30a of the second set of bars 36. When the first and second sets of bars 35,36 are fully engaged with a gear, a dog 20 is located between each pair of adjacent engagement faces 43. The dimensions of the dogs 20 and the ends of the bars are preferably such that there is little movement of each dog between the engagement face 43 of the acceleration bar and the engagement face 43 of the deceleration bar when the gear moves from acceleration to deceleration, or vice versa, to ensure that there is little or no backlash in the gear.

The actuator assembly 38 controls the movement of the first and second sets of engagement bars 35,36. The assembly 38 includes a frame member 40, an actuator 46, a first actuator member 48 and first and second helical springs 50,52. Movement of the first set of engagement bars 35 is controlled by movement of the first actuator member 46, which is controlled by the actuator 46. The first and second springs 50,52 are arranged to bias the first set of engagement bars to move in an axial direction when they are in driving engagement with a gear wheel and are unable to move. The assembly 38 includes, a second actuator member 58 and third and fourth helical springs 60,62. Movement of the second set of engagement bars 36 is controlled by movement of the second actuator member 56, which is controlled by the actuator 46. The third and fourth helical springs 60,62 are arranged to bias the second set of engagement bars to move in an axial direction when they are in driving engagement with a gear wheel and are unable to move.

Each actuator member 48,58 is arranged to extend approximately 180 degrees around the groove 102 of its respective set of engagement bars and includes a semi-annular part that is located within the groove 102. Each set of engagement bars 35,36 can rotate relative to its respective actuator member 48,58 and is caused to move axially along the output shaft 3 by the actuator member 48,58 applying a force to the annular member 100.

The operation of the first gear selector mechanism 29 will now be described with reference to FIGS. 5a-5f which for clarity illustrate diagrammatically the movement of the first and second bar sets 35,36 by the relative positions of only one bar from each set.

FIG. 5a shows the first and second bar sets 35,36 in a neutral position, that is, neither bar set is engaged with a gear wheel. FIG. 5b shows the first and second bar sets moving into engagement with the first gear wheel 13 under the action of the actuator assembly 38.

FIG. 5c shows a condition when the first gear wheel 13 is fully engaged, that is, the bars 28,30 are interleaved with the first group of dogs 20. The actuator 46 is arranged such that the actuator members 48,58 maintain the first and second bar sets 35,36 in engagement with the first gear wheel 13. Accordingly, drive is transferred through the first gear wheel 13 to the output shaft 3 via the first bar set 35 when decelerating and via the second bar set 36 when accelerating.

Whilst accelerating (first gear wheel 13 rotating in the direction of arrow B in FIG. 5c) using the first gear train 5, the engagement feces 43 of the bars of the first bar set 35 are not loaded, whilst the engagement faces 43 of the bars of the second bar set 36 are loaded. When a user, or an engine management system (not shown) wishes to engage the second gear train 7, the actuator 46 is activated causing the frame 40 to move such that the first actuator member 48 causes the bars 28 of the first bar set 35 to slide axially along the keyways 41 in the sleeve 34 thereby disengaging the first bar set 35 from the first gear wheel 13 (see FIG. 5d).

Movement of the frame 40 causes the fourth helical spring 62 to act on the second actuator member 58, which tries to move the second bar set 36 towards the third gear wheel 17. However, because the second bar set 36 is loaded, i.e. is driving the first gear wheel 13, it cannot be disengaged from the first gear wheel 13, and the second bar set 36 remains stationary, with the resiliency of the fourth helical spring 62 biasing it towards the third gear wheel 17.

When the first bar set 35 slides axially along the output shaft 3, the engagement faces 43 engage the second group of dogs 20 (see FIG. 5e). The bars 28 then begin to drive the third gear wheel 17 in the direction of Arrow C in FIG. 5e and drive is transmitted between the input and output shafts 1,3 via the second gear train 7. As this occurs, the second bar set 36 ceases to be loaded, and is free to disengage from the first group of dogs 20. Since the second bar set 36 is biased by the fourth helical spring 62 it slides axially along the keyways 41 in the sleeve 34 thereby completing the disengagement of the first gear wheel 13 from the output shaft 3. The second bar set 36 slides along the keyways 41 until it engages the third gear wheel 17, thereby completing engagement of the third gear wheel 17 with the output shaft 3 (see FIG. 5f).

This method of selecting gear trains substantially eliminates torque interruption since the second gear train 7 is engaged before the first gear train 5 is disengaged, thus momentarily, the first and second gear trains 5,7 are simultaneously engaged and locked for rotation with the output shaft 3, until the newly engaged gear wheel overdrives the original gear wheel.

When a gear wheel is engaged by both the first and second bar sets 35,36 it is possible to accelerate or decelerate using a gear wheel pair with very little backlash occurring when switching between the two conditions. Backlash is the lost motion experienced when the dog moves from the engagement face 43 of the acceleration bar to the engagement face 43 of the deceleration bar when moving from acceleration to deceleration, or vice versa. A conventional dog-type transmission system has approximately 30 degrees of backlash. A typical transmission system for a car in accordance with the current invention has backlash of less than four degrees.

Backlash is reduced by minimizing the clearance required between an engagement member and a dog during a gear shift: that is, the clearance between the dog and the following engagement member (see measurement ‘A’ in FIG. 5b). The clearance between the dog and the following engagement member is in the range 0.5 mm-0.03 mm and is typically less than 0.2 mm. Backlash is also a function of the retention angle, that is, the angle of the engagement face 43, which is the same as the angle of the undercut on the engagement face of the dog 20a. The retention angle influences whether there is relative movement between the dog and the engagement face 43. The smaller the retention angle, the less backlash that is experienced. The retention angle is typically between 2.5 and 15 degrees.

Transition from the second gear train 7 to the first gear train 5 whilst decelerating is achieved by a similar process.

Whilst decelerating in the second gear train 7 the engagement surfaces 43 of the bars of the first bar set 35 are not loaded, whilst the engagement surfaces 43 of the bars of the second bar set 36 are loaded. When a user, or an engine management system (not shown) wishes to engage the first gear train 5 the actuator 46 is activated to move the frame member 40 and hence the first actuator member 48 axially, causing the first bar set 35 to slide axially in the keyways 41 along the output shaft 3 in the direction of the first gear wheel 13, thereby disengaging the first bar set 35 from the third gear wheel 17.

Axial movement of the frame 40 compresses the third helical spring 60 since the second bar set 36 is loaded and remains stationary, i.e. it is drivingly engaged with the dogs 20 on the third gear wheel 17. This biases the second bar set 36 towards the first gear wheel 13.

As the first bar set 35 slides axially in the keyways 41 and engages the dogs 20 on the first gear wheel 13 and begins to drive the first gear wheel 13 such that energy is transmitted between the input and output shafts 1,3 by way of the first gear train 5. As this occurs, the second bar set 36 ceases to be loaded and the resiliency of the third helical spring 60 causing it to slide axially within the keyways 41 along the output shaft 3 towards the first gear wheel 13, thereby completing disengagement of the third gear wheel 17. The second bar set 36 continues to slide within the keyways 41 along the output shaft 3 until it engages the first gear wheel 13, thereby completing engagement of the first gear wheel 13 with the output shaft 3.

Kick-down shifts, that is a gear shift from a higher gear train to a larger gear train but where acceleration takes place, for example when a vehicle is traveling up a hill and the driver selects a lower gear to accelerate up the hill, preferably have a brief torque interruption to allow disengagement prior to the shift.

Use of the instantaneous gear selector mechanism leads to improved performance, lower fuel consumption and lower emissions since drive interruption during gear changes is substantially eliminated. Also the system is a more compact design than conventional gearboxes leading to a reduction in gearbox weight.

Safety System

The transmission includes a safety system 55 arranged to block adjacent selector mechanisms from applying torque to the output shaft 3 in opposed directions. The safety system 55 includes control arms that are arranged to control the separation between engagement bars between two adjacent selector mechanisms. The operation of the safety devices will now be described with reference to FIGS. 1,6a to 6f, which show a sequence of gear changes from neutral selecting the first gear train (ratio) 5, second gear train 7 and third gear train 9.

The transmission is arranged such that the deceleration drive faces first set of engagement bars 35 of the first gear selector device 29 are engageable with the first gear wheel 13 and the acceleration drive faces are engageable with the third gear wheel 17 (see FIG. 1). The second set of engagement bars set 24 of the first gear selector device 29 is arranged such that the acceleration drive faces are engageable with the first gear wheel 13 and the deceleration faces are engageable with the third gear wheel 17.

The first set of engagement bars 35 of the second selector mechanism 31 is arranged such that the acceleration drive faces are engageable with the fifth gear wheel 21 and the deceleration drive faces are engageable with the seventh gear wheel 25. The second set of engagement bars 36 is arranged such that the deceleration drive faces are engageable with the fifth gear wheel 21 and the acceleration faces are engageable with the seventh gear wheel 25.

The first set of engagement bars 35 of the third selector mechanism 33 is arranged such that the acceleration drive faces are engageable with the ninth gear wheel 16 and the deceleration drive faces are engageable with the eleventh gear wheel 22. The second set of engagement members 36 is arranged such that the deceleration drive faces are engageable with the ninth gear wheel 16 and the acceleration faces are engageable with the eleventh gear wheel 22.

For the first and second selector mechanism pair 29,31, the safety system includes a first control arm 57 that protrudes from the first actuator member 48 of the second selector mechanism 31 and preferably includes a part that is arranged substantially parallel to the output shaft 3. The first control arm 57 ensures that there is a minimum predetermined separation between the second set of engagement bars 36 of the first selector mechanism 29 and the first set of engagement bars 35 of the second selector mechanism 31. This is achieved by selecting the length of the first control arm 57 to ensure that there is a clearance between one of those engagement member sets and its gear wheel when the other engagement member set is engaged with its gear wheel. Thus the first control arm 57 acts as a buffer between the second actuator member 58 of the first selector mechanism 29 and the first actuator member 48 of the second selector mechanism 33, and hence the sets of engagement bars 35,36. This ensures that the deceleration faces of the second engagement set of engagement bars 36 of the first selector device 29 cannot be engaged with the third gear wheel 17 when the acceleration drive faces of the first set of engagement bars 35 of the second gear selector device 33 are engaged with the fifth gear wheel 21, and vice versa. This prevents lockup conflicts from occurring.

A second control arm 59 is similarly arranged to the first control arm 57. The second control arm 59 protrudes from the second actuator member 58 and preferably includes a part that extends substantially parallel to the output shaft 2. The second control arm 59 ensures that there is a minimum predetermined separation between the first set of engagement bars 35 of the first selector mechanism 29 and the second set of engagement bars 36 of the second selector mechanism 33. Thus the second control arm 59 acts as a buffer between the first actuator member 48 of the first selector mechanism 29 and the second actuator member 58 of the second selector mechanism 33, and hence the sets of engagement bars 35,36. This ensures that the acceleration faces of the first set of engagement bars 35 of the first selector mechanism 29 cannot be engaged with the third gear wheel 17 when the deceleration drive faces of the second set of engagement bars 36 of the second selector mechanism 33 are engaged with the fifth gear wheel 21, and vice versa.

The control arms 57,59 can be shaped and dimensioned to achieve the above effect.

FIG. 1 shows the transmission in neutral, that is none of the selector mechanisms 29,31,33 engage either of their respective gear wheels. FIGS. 6a-b show movement of the first selector mechanism 29 to engage the first gear wheel 13. FIG. 6c shows the first set of engagement members 35 moving into engagement with the third gear wheel 17. The second set of engagement members are still engaged with the first gear wheel 13. FIG. 6d shows the third gear wheel 17 completely engaged by the first selector mechanism 29 since the second set of engagement bars 36 has become unloaded and has engaged the third gear wheel 17. Since movement is across a single selector mechanism the selection is inherently safe and no lockup can occur.

Due to the presence of the first and second control arms 57,59 the second selector mechanism 31 is physically prevented from engaging the fifth gear wheel 21. Torque is applied to the output shaft 3 in the opposite direction from that applied via the first selector mechanism 29 via the third gear wheel 17.

FIGS. 6e-f show selection of the third gear train 9. When the user or the engine management system (not shown) selects the third gear train 9 and the acceleration drive faces of the first selector mechanism 29 are driving the third gear wheel 17 and hence the deceleration drive faces are unloaded, the acceleration drive faces of the second selector mechanism 31 move into engagement with the fifth gear wheel 21 and the action of the first control member 57 pushes the deceleration drive faces of the first selector mechanism 29 out of engagement with the third gear wheel 17 into neutral. This prevents the possibility of lockup occurring since torque cannot be applied to the output shaft 3 in opposite directions.

To complete engagement of the fifth gear wheel 21, the deceleration drive faces of the second selector mechanism 31 move into engagement with it. The presence of the second control arm 59 pushes the acceleration drive faces of the first selector mechanism 29 out of engagement with the third gear wheel 17 into neutral. This is possible since the acceleration drive faces of the first selector mechanism 29 are no longer loaded since the third gear train 9 over drives the second gear train 7 when the fifth gear wheel 21 is engaged by the acceleration drive faces of the second selector mechanism 31.

Moving from the third gear train 9 to the second gear train 7 has a similar blocking effect to prevent lockup occurring during a braking downshift.

Selection of the fourth gear train 11 from the third gear train 9 is across a single selector mechanism and is inherently safe. Selection of the fifth gear train 12 from the fourth gear train 11 is similar to the selection between the second and third gear trains 7,9.

Thus, the potentially catastrophic lockup condition of two gear wheels being locked for rotation with the shaft in opposed directions is prevented from occurring when changing between gears that are not engageable by a single selector mechanism, in this case between 2^{nd} and 3^{rd} gears.

The above arrangement can be repeated for any number of selector mechanisms mounted on the output shaft 3. For example, FIG. 1 shows a transmission having three selector mechanisms 29,31,33. The third selector mechanism 33 includes a similar actuator assembly 38 and safety system 55 as described above.

Modifications can be made to the above embodiment that are within the scope of the invention. For example, the selector assemblies and rotatably mounted gear wheels can be mounted on the input shaft, and the fixed gear wheels on the output shaft. The control arms can be connected between the acceleration engagement bars of a first selector mechanism and the deceleration engagement bars of an adjacent selector mechanism. This enables the control arms to push and pull the sets of engagement bars.

An alternative actuator assembly can be used that is arranged such that a fork assembly is mounted on the selector rod, and the selector rod is provided parallel to the output shaft and adjacent thereto. The fork assembly includes a fork and first and second annular disc springs mounted about the output shaft. The first and second disc springs have three arms, with each arm having a first part that extends circumferentially around a part of the spring and a second part that extends radially inwards.

The fork has a first pair of arcuate members arranged to engage the first disc spring. The arcuate members are arranged such that the first disc spring can rotate with the input shaft 1 between the arcuate members and such that axial movement of the fork parallel to the output shaft moves the arcuate members and hence the first disc spring axially along the shaft if the first disc spring is free to move, or biases the first disc spring to move in the same direction as the fork if the first disc spring is unable to move. The fork has a second pair of arcuate members arranged to engage and act upon the second disc spring in a similar manner.

The position of the fork relative to the first and third gear wheels can be adjusted by movement of the selector rod in the axial direction.

The inner edges of the first disc spring are fixed to the bar in the first bar set and the inner edges of the second disc spring are fixed to the bars in the second bar set. When the fork moves, thereby moving or loading the disc springs, the engagement bar sets are likewise moved or biased to move.

This arrangement is of the type disclosed in WO 2004/099654, WO 2005/005868, WO 2005/005869, WO 2005/024261 and WO 2005/026570 and the invention is applicable to those arrangements. The invention is also applicable to the arrangement(s) of selector mechanisms described in those documents.

The safety system can include dynamic regulation of the control arms, for example the length of the control arms could be adjustable, such as telescopic, and the dynamic regulation of the control arms can select the appropriate length of control arm for a particular shift situation.

In the embodiment described above, each selector mechanism uses a single actuator to move both the first and second sets of engagement bars, hence one actuator per selector mechanism. The invention is also applicable to similar selector devices that use a first actuator for the first set of engagement bars and a second actuator for the second set of engagement bars, thus two actuators per selector mechanism. Each actuator is arranged to move its set of engagement bars independently of the other actuator. The actuators may be operated by a microprocessor and the movement controlled by software.

The invention is also applicable to transmission arrangements wherein the selector devices are located on different shafts, for example is applicable to the arrangement disclosed in PCT/GB2006/000743 where the selector devices are arranged on alternate shafts.

The transmission system can be used in any vehicle for example, road cars, racing cars, lorries, motorcycles, bicycles, trains, trams, coaches, earth removal vehicles such as bulldozers and diggers, cranes, water craft such as hovercraft and ships, aircraft including aeroplanes and helicopters, and military vehicles. The system can also be used in any machine that has first and second rotatable bodies wherein drive is to be transmitted from one of the rotatable bodies to the other with variable speed and torque characteristics, such as transportation systems and manufacturing equipment including lathes, milling machines and dedicated production systems.

1. A transmission system including:
a first gear train having a first gear element;
a second gear train having a second gear element;
a first gear selector device arranged for selecting the first gear element;
a first actuator for controlling the operation of the first gear selector device;
a second gear selector device arranged for selecting the second gear element;
a second actuator for controlling operation of the second gear selector device; and
a safety device for preventing the first and second gear selector devices from simultaneously applying torque to the first and second gear elements in opposed directions.

2. A transmission system according to claim 1, wherein the safety device is a blocking device,

3. A transmission system according to claim 1, wherein the first gear element is rotatably mounted on a first shaft and the first gear selector device is arranged to selectively lock the first gear element for rotation with the first shaft.

4. A transmission system according to claim 1, wherein the second gear element is rotatably mounted on the first shaft or a second shaft and the second gear selector device is arranged to selectively lock the second gear element for rotation with the first shaft or the second shaft.

5. A transmission system according to claim 1, wherein the safety device is arranged to prevent the first selector device from applying an accelerating force to the first gear element and the second gear selector device from applying a decelerating force to the second gear element simultaneously.

6. A transmission system according to claim 1, wherein the safety device is arranged to prevent the first selector device from applying a decelerating force to the first gear element and the second gear selector device from applying an accelerating force to the second gear element simultaneously.

7. A transmission system according to claim 2, wherein the blocking device is arranged to control the separation of engagement members of the first and second gear selector devices.

8. A transmission system according to claim 1, wherein the first gear selector device includes first and second sets of engagement members for engaging drive formations on the first gear element and the second gear selector device includes first and second sets of engagement members for engaging drive formations on the second gear element.

9. A transmission system according to claim 8, wherein the safety device is arranged to control the separation between the first set of engagement members of the first gear selector device and the second set of engagement members of the second gear selector device.

10. A transmission system according to according to claim 9, further including a first control member arranged to limit the relative movement between the first set of engagement members of the first gear selector device and the second set of engagement members of the second gear selector device to prevent simultaneous engagement with their respective gear elements that would cause torque to be applied in opposite directions.

11. A transmission system according to claim 10, wherein the first control member is arranged to provide a predetermined minimum separation between acceleration parts of the engagement members of the second gear selector device and deceleration parts of the engagement members of the first gear selector device.

12. A transmission system according to claim 10, wherein the first control member is an arm.

13. A transmission system according to claim 8, wherein the safety device is arranged to control the separation between the second set of engagement members of the first gear selector device and the first set of engagement members of the second gear selector device.

14. A transmission system according to claim 13, further including a second control member arranged to limit the relative movement between the sets of engagement members to prevent simultaneous engagement with their respective gear elements that would cause torque to be applied in opposite directions.

15. A transmission system according to claim 14, wherein the second control member is arranged to provide a predetermined minimum separation between deceleration parts of the engagement members of the second gear selector device and acceleration parts of the engagement members of the first gear selector device.

16. A transmission system according to claim 15, wherein the second control member is an arm.

17. A transmission system according to claim 8, wherein the first gear selector device is arranged such that when a braking force is transmitted the first set of engagement members drivingly engages the first gear element, and the second set of engagement members is in an unloaded condition, and when a driving force is transmitted the second set of engagement members drivingly engages the first gear element, and the second set of engagement members is then in an unloaded condition.

18. A transmission system according to claim 8, wherein the second gear selector device is arranged such that when a braking force is transmitted the second set of engagement members drivingly engages the third gear element and the first set of engagement members is in an unloaded condition, and when a driving force is transmitted the first set of engagement members drivingly engages the third gear element and the second set of engagement members is then in an unloaded condition.

19. A transmission system according to claim 8, wherein the first and/or second gear selector devices is/are arranged to bias a loaded set of engagement members towards an unengaged gear element without disengaging the loaded set of engagement members from the engaged gear element.

20. A transmission system according to claim 1, wherein the first selector device is arranged to select between a mode of operation with respect to the first gear element selected from the group consisting of: fully engaged in both torque directions; disengaged in both torque directions; engaged in the forward torque direction while disengaged in the reverse torque direction; and disengaged in the forward torque direction while engaged in the reverse torque direction.

21. A transmission system according to claim 1, wherein the second gear selector device is arranged to select between a mode of operation with respect to the second gear element selected from the group consisting of: fully engaged in both torque directions; disengaged in both torque directions; engaged in the forward torque direction while disengaged in the reverse torque direction; and disengaged in the forward torque direction while engaged in the reverse torque direction.
